(19) United States
(12) Patent Application Publication
(10) Pub. No.: US 2010/0261828 A1
(43) Pub. Date: Oct. 14, 2010

(54) RESIN COMPOSITION

(75) Inventors: Takuya Tomoda, Tokyo (JP); Yasuhito Inagaki, Tokyo (JP)

Correspondence Address: WENDEROTH, LIND & PONACK, L.L.P., 1030 15th Street, N.W.,, Suite 400 East, Washington, DC, 20005-1503, US

(73) Assignees: Teijin Chemicals Ltd.; Sony Corporation

(21) Appl. No.: 12/734,548

(22) PCT Filed: Nov. 6, 2008
(86) PCT No.: PCT/JP2008/070621

§ 371 Date: May 7, 2010

(30) Foreign Application Priority Data
Nov. 8, 2007 (JP) 2007-290391

(51) Int. Cl. C08K 3/34; C08L 81/08; C08L 69/00

(52) U.S. Cl. 524/449; 525/189; 524/456; 524/502; 524/451

(57) ABSTRACT

It is an object of the present invention to provide a resin composition which is excellent in flame retardancy and heat resistance and comprises a flame retardant containing no halogen.

The present invention is a resin composition comprising 100 parts by weight of an aromatic polycarbonate resin (component A), 0.001 to 8 parts by weight of a flame retardant (component B) and 0.01 to 6 parts by weight of a fluorine-containing dripping inhibitor (component C), wherein

the flame retardant (component B) is obtained by introducing a sulfonic acid group and/or a sulfonic acid base into an aromatic polymer in an amount of 0.1 to 2.5 wt % in terms of sulfur.

### TECHNICAL FIELD

The present invention relates to a resin composition comprising a polycarbonate resin. Specifically, it relates to a resin composition having excellent flame retardancy and heat resistance. More specifically, it relates to a resin composition which comprises a flame retardant containing no halogen from the viewpoint of environmental conservation.

### BACKGROUND ART

An aromatic polycarbonate resin has transparency and excellent flame retardancy and heat resistance and is therefore used in a wide variety of fields. However, there is a case where the flame retardancy of the aromatic polycarbonate resin is not high enough to meet the recent growing requirements for the dimensional stability and high stiffness of electronic and electric equipment parts. In addition, such high flame retardancy as UL (Underwriters' Laboratory standards of the U.S.)-94 V-0 is now often required, and the application of the aromatic polycarbonate resin is limited.

Heretofore, to provide flame retardancy to the aromatic polycarbonate resin, there has been proposed a method in which a halogen-based compound or a phosphorus-based compound is added. This method is used for OA equipment and home appliance products which are strongly desired to be flame retardant. However, dehalogenation is strongly desired from the viewpoint of recent environmental problems, and it is desired to reduce the amount of a flame retardant used. The phosphorus-based compound also has such problems as the generation of a gas at the time of injection molding and the deterioration of the heat resistance of a resin composition and cannot satisfy the requirement for the heat resistance of electronic and electric equipment parts.

Therefore, there is proposed a method for flame retarding an aromatic polycarbonate resin by adding an organic metal salt as a material which satisfies the requirements for dehalogenation and dephosphorization (refer to Patent Documents 1 and 2).

To improve flame retardancy, there are also proposed methods in which flame retardancy is improved by adjusting the quality of a conventionally known flame retardant to a suitable level without changing the type and amount of the flame retardant. For example, there is proposed a method for controlling the amount of a sulfonic acid group of a metal salt which is obtained by introducing a sulfonic acid group and/or a sulfonic acid base into an aromatic polymer used as a flame retardant (refer to Patent Document 3, Patent Document 4 and Patent Document 5). However, these proposals are very interesting because all of them reveal the factor of improving compatibility with a resin and flame retardancy but do not investigate the heat stability and heat resistance of a resin composition. There is also proposed a method for mixing a resin composition comprising a reinforcing filler with a flame retardant obtained by introducing a sulfonic acid group and/or a sulfonic acid base into an aromatic polymer (refer to Patent Document 6). In this proposal, the influence of the amount of the sulfonic acid group upon the flame retardancy of the resin composition comprising a reinforcing filler is not made clear.

### (Patent Document 1) JP-B 54-32456

### (Patent Document 2) JP-B 60-19335

### (Patent Document 3) JP-A 2005-272538

### (Patent Document 4) JP-A 2005-272539

### (Patent Document 6) JP-A 2002-226697

### DISCLOSURE OF THE INVENTION

It is an object of the present invention to provide a resin composition having excellent heat stability, flame retardancy and heat resistance. It is another object of the present invention to provide a resin composition which comprises a flame retardant containing no halogen from the viewpoint of environmental conservation. It is still another object of the present invention to provide a molded article of this resin composition. It is a further object of the present invention to provide a method of producing this resin composition.

The inventors of the present invention have conducted intensive studies to attain the above objects and have found that, when a flame retardant (component B) into which a specific amount of a sulfonic acid group and/or a sulfonic acid base has been introduced and a fluorine-containing dripping inhibitor (component C) are mixed with an aromatic polymer, a resin composition having excellent heat stability, flame retardancy and heat resistance is obtained. The present invention has been accomplished based on this finding.

That is, the present invention is a resin composition comprising 100 parts by weight of an aromatic polycarbonate resin (component A), 0.001 to 8 parts by weight of a flame retardant (component B) and 0.01 to 6 parts by weight of a fluorine-containing dripping inhibitor (component C), wherein

the flame retardant (component B) is an aromatic polymer in which a sulfonic acid group and/or a sulfonic acid base being introduced in an amount of 0.1 to 2.5 wt % in terms of sulfur.

The present invention is a molded article of the above resin composition.

The present invention is a method of producing a resin composition by mixing together 100 parts by weight of an aromatic polycarbonate resin (component A), 0.001 to 8 parts by weight of a flame retardant (component B) and 0.01 to 6 parts by weight of a fluorine-containing dripping inhibitor (component C), wherein

the flame retardant (component B) is an aromatic polymer in which a sulfonic acid group and/or a sulfonic acid base being introduced in an amount of 0.1 to 2.5 wt % in terms of sulfur.

### BEST MODE FOR CARRYING OUT THE INVENTION

The present invention will be described in more detail hereinunder.

### (Component A: Aromatic Polycarbonate Resin)

The aromatic polycarbonate resin is obtained by reacting a diphenol with a carbonate precursor. Examples of the reaction include interfacial polycondensation, melt transesterification, the solid-phase transesterification of a carbonate prepolymer and the ring-opening polymerization of a cyclic carbonate compound.

Typical examples of the diphenol used herein include hydroquinone, resorcinol, 4,4′-biphenol, 1,1-bis(4-hydroxyphenyl) ethane, 2,2-bis(4-hydroxyphenyl)propane (commonly known as “bisphenol A”), 2,2-bis(4-hydroxy-3-methylphenyl)propane, 2,2-bis(4-hydroxyphenyl)butane, 1,1-bis(4-hydroxyphenyl)-1-phenylethane, 1,1-bis(4-hydroxyphenyl)cyclohexane, 1,1-bis(4-hydroxyphenyl)-3,3,5-trimethylcyclohexane, 2,2-bis(4-hydroxyphenyl)pentane, 4,4′-(p-phenylenediisopropylidene)diphenol, 4,4′-(m-phenylenediisopropylidene) diphenol, 1,1-bis(4-hydroxyphenyl)-4-isopropylcyclohexane, bis(4-hydroxyphenyl)oxide, bis(4-hydroxyphenyl)sulfide, bis(4-hydroxyphenyl)sulfoxide, bis(4-hydroxyphenyl)sulfone, bis(4-hydroxyphenyl)ketone, bis(4-hydroxyphenyl)ester, bis(4-hydroxy-3-methylphenyl)sulfide, 9,9-bis(4-hydroxyphenyl)fluorene and 9,9-bis(4-hydroxy-3-methylphenyl)fluorene. Out of these, bis(4-hydroxyphenyl)alkanes are preferred, and bisphenol A (may be abbreviated as “BPA” hereinafter) is particularly preferred from the viewpoint of impact resistance.

In the present invention, a special polycarbonate which is produced by using another diphenol may be used as the component A, besides bisphenol A-based polycarbonates which are general-purpose polycarbonates.

For example, polycarbonates (homopolymers or copolymers) obtained from 4,4′-(m-phenylenediisopropylidene)diphenol (may be abbreviated as “BPM” hereinafter), 1,1-bis(4-hydroxyphenyl)cyclohexane, 1,1-bis(4-hydroxyphenyl)-3,3,5-trimethylcyclohexane (may be abbreviated as “Bis-TMC” hereinafter), 9,9-bis(4-hydroxyphenyl)fluorene and 9,9-bis(4-hydroxy-3-methylphenyl)fluorene (may be abbreviated as “BCF” hereinafter) as part or all of the diphenol component are suitable for use in fields in which the requirements for stability to dimensional change by water absorption and form stability are very strict. These diphenols except BPA are used in an amount of preferably not less than 5 mol %, particularly preferably not less than 10 mol % of the whole diphenol component constituting the polycarbonates.

Particularly when high stiffness and excellent resistance to hydrolysis are required, the component A constituting the resin composition is particularly preferably one of the following copolycarbonates (1) to (3).
(1) A copolycarbonate which comprises 20 to 80 mol % (preferably 40 to 75 mol %, more preferably 45 to 65 mol %) of BPM and 20 to 80 mol % (preferably 25 to 60 mol %, more preferably 35 to 55 mol %) of BCF based on 100 mol % of the diphenol component constituting the polycarbonate.
(2) A copolycarbonate which comprises 10 to 95 mol % (preferably 50 to 90 mol %, more preferably 60 to 85 mol %) of BPA and 5 to 90 mol % (preferably 10 to 50 mol %, more preferably 15 to 40 mol %) of BCF based on 100 mol % of the diphenol component constituting the polycarbonate.
(3) A copolycarbonate which comprises 20 to 80 mol % (preferably 40 to 75 mol %, more preferably 45 to 65 mol %) of BPM and 20 to 80 mol % (preferably 25 to 60 mol %, more preferably 35 to 55 mol %) of Bis-TMC based on 100 mol % of the diphenol component constituting the polycarbonate.

These special polycarbonates may be used alone or in combination of two or more. They may be mixed with a commonly used bisphenol A type polycarbonate.

The production processes and characteristic properties of these special polycarbonates are detailed in, for example, JP-A 6-172508, JP-A 8-27370, JP-A 2001-55435 and JP-A 2002-117580.

Out of the above polycarbonates, polycarbonates whose water absorption coefficient and Tg (glass transition temperature) have been adjusted to the following ranges by controlling their compositions have high resistance to hydrolysis and rarely warp after molding. Therefore, they are particularly preferred in fields in which form stability is required.
(i) A polycarbonate having a water absorption coefficient of 0.05 to 0.15%, preferably 0.06 to 0.13% and a Tg of 120 to 180° C., or
(ii) a polycarbonate having a Tg of 160 to 250° C., preferably 170 to 230° C. and a water absorption coefficient of 0.10 to 0.30%, preferably 0.13 to 0.30%, more preferably 0.14 to 0.27%.

The water absorption coefficient of a polycarbonate is a value obtained by measuring the moisture content of a disk-like test specimen having a diameter of 45 mm and a thickness of 3.0 mm after the specimen is immersed in 23° C. water for 24 hours in accordance with ISO62-1980. Tg (glass transition temperature) is a value measured with a differential scanning calorimeter (DSC) in accordance with JIS K7121.

The carbonate precursor is a carbonyl halide, diester carbonate or haloformate, as exemplified by phosgene, diphenyl carbonate and dihaloformates of a diphenol.

For the manufacture of an aromatic polycarbonate resin from a diphenol and a carbonate precursor by interfacial polymerization, a catalyst, a terminal capping agent and an antioxidant for preventing the oxidation of the diphenol may be optionally used. The aromatic polycarbonate resin includes a branched polycarbonate resin obtained by copolymerizing a polyfunctional aromatic compound having 3 or more functional groups, a polyester carbonate resin obtained by copolymerizing an aromatic or aliphatic (including alicyclic) bifunctional carboxylic acid, a copolycarbonate resin obtained by copolymerizing a bifunctional alcohol (including an alicyclic bifunctional alcohol), and a polyester carbonate resin obtained by copolymerizing the bifunctional carboxylic acid and the bifunctional alcohol. It may also be a mixture of two or more of the obtained polycarbonate resins.

The branched polycarbonate resin can provide dripping preventing ability to the resin composition of the present invention. Examples of the polyfunctional aromatic compound having 3 or more functional groups used in the branched polycarbonate resin include phloroglucin, phloroglucide, trisphenols such as 4,6-dimethyl-2,4,6-tris(4-hydroxydiphenyl) heptene-2,2,4,6-trimethyl-2,4,6-tris(4-hydroxyphenyl) heptane, 1,3,5-tris(4-hydroxyphenyl) benzene, 1,1,1-tris(4-hydroxyphenyl) ethane, 1,1,1-tris(3,5-dimethyl-4-hydroxyphenyl) ethane, 2,6-bis(2-hydroxy-5-methylbenzyl)-4-methylphenol and 4-{4-[1,1-bis(4-hydroxyphenyl) ethyl]benzene}-α,α-dimethylbenzylphenol, tetra(4-hydroxyphenyl) methane, bis(2,4-dihydroxyphenyl) ketone, 1,4-bis(4,4-dihydroxytriphenylmethyl) benzene, and trimellitic acid, pyromellitic acid, benzophenone tetracarboxylic acid and acid chlorides thereof. Out of these, 1,1,1-tris(4-hydroxyphenyl) ethane and 1,1,1-tris(3,5-dimethyl-4-hydroxyphenyl)ethane are preferred, and 1,1,1-tris(4-hydroxyphenyl) ethane is particularly preferred.

The amount of the constituent unit derived from the polyfunctional aromatic compound in the branched polycarbonate is 0.01 to 1 mol %, preferably 0.05 to 0.9 mol %, particularly preferably 0.05 to 0.8 mol % based on 100 mol % of the total of the constituent unit derived from the diphenol and the constituent unit derived from the polyfunctional aromatic compound.

In the case of the melt transesterification process, a branched structure unit may be produced as a side reaction. The amount of the branched structure unit is 0.001 to 1 mol %, preferably 0.005 to 0.9 mol %, particularly preferably 0.01 to 0.8 mol % based on 100 mol % of the total of it and the constituent unit derived from the diphenol. The amount of the branched structure can be calculated by ¹H-NMR measurement.

The aliphatic bifunctional carboxylic acid is preferably α,ω-dicarboxylic acid. Preferred examples of the aliphatic bifunctional carboxylic acid include linear saturated aliphatic dicarboxylic acids such as sebacic acid (decanedioic acid), dodecanedioic acid, tetradecanedioic acid, octadecanedioic acid and icosanedioic acid, and alicyclic dicarboxylic acids such as cyclohexanedicarboxylic acid. The bifunctional alcohol is preferably an alicyclic diol such as cyclohexanedimethanol, cyclohexanediol or tricyclodecanedimethanol.

Further, a polycarbonate-polyorganosiloxane copolymer obtained by copolymerizing a polyorganosiloxane unit may also be used.

An interfacial polymerization process, melt transesterfication process, carbonate prepolymer solid-phase transesterification process and cyclic carbonate compound ring-opening polymerization process which are processes for producing a polycarbonate resin are well known through documents and patent publications.

To produce the resin composition of the present invention, the viscosity average molecular weight (M) of the aromatic polycarbonate resin is not particularly limited but is preferably 1×10⁴ to 5×10⁴, more preferably 1.4×10⁴ to 3×10⁴, much more preferably 1.4×10⁴ to 2.4×10⁴.

Satisfactory mechanical properties cannot be obtained from an aromatic polycarbonate resin having a viscosity average molecular weight lower than 1×10⁴. A resin composition obtained from an aromatic polycarbonate resin having a viscosity average molecular weight higher than 5×10⁴ is inferior in general-applicability as it has low flowability at the time of injection molding.

The aromatic polycarbonate resin may be obtained by mixing an aromatic polycarbonate resin having a viscosity average molecular weight outside the above range. Particularly an aromatic polycarbonate resin having a viscosity average molecular weight higher than the above range (5×10⁴) improves the entropy elasticity of a resin. As a result, it exhibits high moldability in gas assist molding which is used to mold a reinforced resin material into a structural member and foam molding. It improves moldability more than the above branched polycarbonate. As a more preferred embodiment, an aromatic polycarbonate resin (component A-1) (may be referred to as “high-molecular weight component-containing aromatic polycarbonate resin” hereinafter) consisting of an aromatic polycarbonate resin having a viscosity average molecular weight of 7×10⁴ to 3×10⁵ (component A-1-1) and an aromatic polycarbonate resin having a viscosity average molecular weight of 1×10⁴ to 3×10⁴ (component A-1-2) and having a viscosity average molecular weight of 1.6×10⁴ to 3.5×10⁴ may also be used as the component A.

In the above high-molecular weight component-containing aromatic polycarbonate resin (component A-1), the molecular weight of the component A-1-1 is preferably 7×10⁴ to 2×10⁵, more preferably 8×10⁴ to 2×10⁵, much more preferably 1×10⁵ to 2×10⁵, particularly preferably 1×10⁵ to 1.6×10⁵. The molecular weight of the component A-1-2 is preferably 1×10⁴ to 2.5×10⁴, more preferably 1.1×10⁴ to 2.4×10⁴, much more preferably 1.2×10⁴ to 2.4×10⁴, particularly preferably 1.2×10⁴ to 2.3×10⁴.

The high-molecular weight component-containing aromatic polycarbonate resin (component A-1) can be obtained by mixing together the above components A-1-1 and A-1-2 in a ratio that ensures that a predetermined molecular weight range is obtained. The content of the component A-1-1 is preferably 2 to 40 wt %, more preferably 3 to 30 wt %, much more preferably 4 to 20 wt %, particularly preferably 5 to 20 wt % based on 100 wt % of the component A-1.

To prepare the component A-1, (1) a method in which the component A-1-1 and the component A-1-2 are polymerized independently and mixed together, (2) a method in which an aromatic polycarbonate resin is produced by employing a method of producing an aromatic polycarbonate resin showing a plurality of polymer peaks in a molecular weight distribution chart by a GPC process as typified by the method disclosed by JP-A 5-306336 in the same system to ensure that the aromatic polycarbonate resin satisfies the condition of the component A-1 of the present invention, or (3) a method in which the aromatic polycarbonate resin obtained by the above production method (2) is mixed with the component A-1-1 and/or the component A-1-2 produced separately may be employed.

The viscosity average molecular weight (M) in the present invention is calculated based on the following equation from the specific viscosity (ηₛₚ) of a solution prepared by dissolving 0.7 g of the aromatic polycarbonate in 100 ml of methylene chloride at 20° C. which is obtained with an Ostwald viscometer based on the following equation.

Specific viscosity(ηₛₚ)=(t−t₀)/t₀

[t₀ is a time (seconds) required for the dropping of methylene chloride and t is a time (seconds) required for the dropping of a sample solution]

ηₛₚ/c=[η]+0.45×[η]²c([η] represents an intrinsic viscosity)

[η]=1.23×10⁻⁴M^{0.83}

c=0.7

The viscosity average molecular weight of the aromatic polycarbonate resin (component A) in the resin composition of the present invention is calculated as follows. That is, the composition is mixed with methylene chloride in a weight ratio of 1:20 to 1:30 to dissolve soluble matter contained in the composition. The soluble matter is collected by cerite filtration. Thereafter, the solvent contained in the obtained solution is removed. After the removal of the solvent, solid matter is dried completely so as to obtain a methylene chloride-soluble solid. The specific viscosity of a solution prepared by dissolving 0.7 g of the solid in 100 ml of methylene chloride is measured at 20° C. as described above so as to calculate the viscosity average molecular weight (M) of the solution therefrom as described above.

(Component B: Flame Retardant Obtained by Introducing a Sulfonic Acid Group and/or a Sulfonic Acid Base into an Aromatic Polymer)

The component B is a flame retardant obtained by introducing a sulfonic acid group and/or a sulfonic acid base into an aromatic polymer.

The sulfonic acid base preferably contains an alkali metal element or an alkali earth metal element. Examples of the alkali metal element include lithium, sodium, potassium, rubidium and cesium. Examples of the alkali earth metal element include beryllium, magnesium, calcium, strontium and barium. An alkali metal element is more preferred. Out of the alkali metal elements, rubidium and cesium having a larger ion radius are preferred when the requirement for transparency is higher. However, as they cannot be used for all purposes and it is difficult to purify them, they may become disadvantageous in terms of cost. Meanwhile, metals having a smaller ion radius such as lithium, potassium and sodium may become disadvantageous in terms of flame retardancy. In consideration of these, alkali metal elements containing a sulfonic acid base may be used for different purposes but potassium having good balance of properties is most preferred in all of these aspects. Potassium and another alkali metal element may be used in combination.

The aromatic polymer contains a monomer unit having an aromatic skeleton in an amount of 1 to 100 mol %. It may have the aromatic skeleton in either the side chain or the main chain.

Specific examples of the aromatic polymer having an aromatic skeleton in the side chain include polystyrene-based resins and acrylonitrile-based resins such as polystyrene (PS), high-impact polystyrene (HIPS: styrene-butadiene copolymer), acrylonitrile-styrene copolymer (AS), acrylonitrile-butadiene-styrene copolymer (ABS), acrylonitrile-chlorinated polyethylene-styrene resin (ACS), acrylonitrile-styrene-acrylate copolymer (ASA), acrylonitrile-ethylene propylene rubber-styrene copolymer (AES) and acrylonitrile-ethylene-propylene-diene-styrene resin (AEPDMS). They may be used alone or in combination of two or more. The aromatic polymer contained in the component B is preferably a polystyrene-based resin and/or an acrylonitrile styrene-based resin.

The weight average molecular weight of the aromatic polymer having an aromatic skeleton in the side chain is preferably 1×10⁴ to 1×10⁷, more preferably 5×10⁴ to 1×10⁶, much more preferably 1×10⁵ to 5×10⁵.

When the aromatic polymer having an aromatic skeleton in the side chain has a weight average molecular weight outside the range of 1×10⁴ to 1×10⁷, it is difficult to disperse a flame retardant uniformly in a resin to be flame retarded, that is, compatibility between them degrades, thereby making it impossible to provide flame retardancy to the resin composition properly.

Examples of the aromatic polymer having an aromatic skeleton in the main chain include polycarbonate (PC), polyphenylene oxide (PPO), polyethylene terephthalate (PET), polybutylene terephthalate (PBT) and polysulfone (PSF). They may be used alone or in combination of two or more. The aromatic polymer having an aromatic skeleton in the main chain may be used as a mixture with another resin (alloy). Specifically, the alloy with another resin is at least one selected from ABS/PC alloy, PS/PC alloy, AS/PC alloy, HIPS/PC alloy, PET/PC alloy, PBT/PC alloy, PVC/PC alloy, PLA (polylactic acid)/PC alloy, PPO/PC alloy, PS/PPO alloy, HIPS/PPO alloy, ABS/PET alloy and PET/PBT alloy.

The content of the monomer unit having an aromatic skeleton in the aromatic polymer is 1 to 100 mol %, preferably 30 to 100 mol %, more preferably 40 to 100 mol %. When the content of the monomer unit having an aromatic skeleton is lower than 1 mol %, it is difficult to disperse a flame retardant uniformly into a resin to be flame retarded, or the introduction rate of a sulfonic acid group and/or a sulfonic acid base into the aromatic polymer decreases, thereby making it impossible to provide flame retardancy to the resin composition properly.

Typical examples of the aromatic skeleton constituting the aromatic polymer include aromatic hydrocarbons, aromatic esters, aromatic ethers (phenols), aromatic thioethers (thiophenols), aromatic amides, aromatic imides, aromatic amide imides, aromatic ether imides, aromatic sulfones and aromatic ether sulfones. Specific examples of these aromatic skeletons include benzene, naphthalene, anthracene, phenanthrene and coronene, all of which have a cyclic structure. Out of these aromatic skeletons, benzene ring and alkylbenzene ring structures are most common.

Examples of the monomer unit except for the aromatic skeleton contained in the aromatic polymer which is not particularly limited include acrylonitrile, butadiene, isoprene, pentadiene, cyclopentadiene, ethylene, propylene, butene, isobutylene, vinyl chloride, α-methylstyrene, vinyl toluene, vinyl naphthalene, acrylic acid, acrylic ester, methacrylic acid, methacrylic ester, maleic acid, fumaric acid and ethylene glycol. They may be used alone or in combination of two or more.

A recycled used material and a mill end discharged in a factory may also be used as the aromatic polymer. That is, the cost can be reduced by using a recycled material as a raw material.

A flame retardant which can provide high flame retardancy when it is contained in a resin to be flame retarded is obtained by introducing a predetermined amount of a sulfonic acid group and/or a sulfonic acid base into the above aromatic polymer. To introduce the sulfonic acid group and/or the sulfonic acid base into the aromatic polymer, for example, the aromatic polymer is sulfonated with a predetermined amount of a sulfonating agent.

In this case, the sulfonating agent used to sulfonate the aromatic polymer desirably has a water content of less than 3 wt %. Specific examples of the sulfonating agent include sulfuric anhydride, fuming sulfuric acid, chlorosulfonic acid and polyalkylbenzene sulfonic acids. They may be used alone or in combination of two or more. A complex of an alkyl phosphate and a Lewis base such as dioxane may also be used as the sulfonating agent.

When the aromatic polymer is sulfonated with 96 wt % concentrated sulfuric acid as the sulfonating agent to produce a flame retardant, a cyano group contained in the polymer is hydrolyzed and converted into an amide group or carboxyl group having a large water absorbing effect, thereby producing a flame retardant containing the amide group or the carboxyl group. When the flame retardant containing a large amount of the amide group or the carboxyl group is used, high flame retardancy can be provided to the resin composition but the resin composition absorbs water from the outside along the passage of time, thereby causing such inconvenience as the discoloration of the resin composition to mar its appearance and the deterioration of the mechanical strength of the resin.

In consideration of these, to sulfonate the aromatic polymer, a predetermined amount of a predetermined sulfonating agent is added to and reacted with a solution prepared by dissolving the aromatic polymer in an organic solvent (chlorine-based solvent). Besides this, for example, a predetermined amount of a predetermined sulfonating agent may be added to and reacted with a dispersion prepared by dispersing the powdery aromatic polymer in an organic solvent (non-dissolved state).

Further, the aromatic polymer may be directly injected into a sulfonating agent and reacted with it, or a sulfonating gas, specifically an sulfuric anhydride (SO₃) gas is directly blown on the powdery aromatic polymer to react with it. Out of these methods, the method in which a sulfonating gas is directly blown on the powdery aromatic polymer without using an organic solvent is preferred.

The sulfonic acid group (—SO₃H) and/or the sulfonic acid base is introduced into the aromatic polymer while it is neutralized with ammonia or an amine compound. Examples of the sulfonic acid base include Na, K, Li, Ca, Mg, Al, Zn, Sb and Sn bases of sulfonic acid.

When the sulfonic acid base is introduced into the aromatic polymer in the flame retardant, higher flame retardancy can be provided to the resin composition than when the sulfonic acid group is introduced into the aromatic polymer. Out of these, Na, K and Ca bases of sulfonic acid are preferred.

The introduction rate of the sulfonic acid group and/or the sulfonic acid base into the aromatic polymer can be controlled by the amount of the sulfonating agent, the reaction time of the sulfonating agent, the reaction temperature, and the type and amount of the Lewis base. Out of these, the introduction rate is preferably controlled by the amount of the sulfonating agent, the reaction time of the sulfonating agent and the reaction temperature.

Stated more specifically, the introduction rate of the sulfonic acid group and/or the sulfonic acid base into the aromatic polymer is preferably 0.1 to 2.5 wt %, more preferably 0.1 to 2.3 wt %, much more preferably 0.1 to 2 wt %, particularly preferably 0.1 to 1.5 wt % in terms of sulfur. The lower limit of the sulfur content is preferably 1 wt %.

When the total introduction rate of the sulfonic acid group and the sulfonic acid base into the aromatic polymer is lower than 0.1 wt %, it is difficult to provide flame retardancy to the resin composition. When the total introduction rate of the sulfonic acid group and the sulfonic acid base into the aromatic polymer is higher than 2.5 wt %, compatibility with the polycarbonate resin (component A) may degrade or the mechanical strength of the resin composition may deteriorate along the passage of time.

The introduction rate of the sulfonic acid group and/or the sulfonic acid base into the aromatic polymer can be easily obtained by quantitatively analyzing the sulfur (S) component contained in the sulfonated aromatic polymer in accordance with a flask combustion method.

In the above-described resin to which a flame retardant prepared by introducing the sulfonic acid group and/or the sulfonic acid base into the aromatic polymer has been added, the thermal decomposition of the flame retardant itself occurs at the time of combustion to promote the charring of the flare contact part of the resin. The charred layer formed at this point covers the entire surface of the resin to block off oxygen from the outside, thereby stopping the combustion of the resin.

The content of the component B in the resin composition of the present invention is 0.001 to 8 parts by weight, preferably 0.01 to 5 parts by weight, more preferably 0.04 to 3 parts by weight based on 100 parts by weight of the aromatic polycarbonate resin (component A).

### (Component C: Fluorine-Containing Dripping Inhibitor)

The fluorine-containing dripping inhibitor (component C) used in the present invention is a fluorine-containing polymer having fibril formability. Examples of the polymer include polytetrafluoroethylene, tetrafluoroethylene-based copolymers (such as tetrafluoroethylene/hexafluoropropylene copolymer), partially fluorinated polymers as disclosed in U.S. Pat. No. 4,379,910, and polycarbonate resins produced from a fluorinated diphenol. Out of these, polytetrafluoroethylene (may be abbreviated as “PTFE” hereinafter) is preferred.

PTFE having fibril formability has an extremely high molecular weight and tends to become fibrous through the bonding of PTFE molecules by an external function such as shearing force. The molecular weight of PTFE is 1,000,000 to 10,000,000, more preferably 2,000,000 to 9,000,000 in terms of number average molecular weight obtained from its standard specific gravity. PTFE in solid form or aqueous dispersion form may be used. A mixture of PTFE having fibril formability and another resin may be used to improve dispersibility in a resin and obtain excellent flame retardancy and mechanical properties.

Commercially products of PTFE having fibril formability include the Teflon (registered trademark) 6J of Du Pont-Mitsui Fluorochemicals Co., Ltd. and the Polyfuron MPA FA500 and F-201L of Daikin Industries, Ltd. Typical commercially available products of the PTFE aqueous dispersion include the Fluon AD-1 and AD-936 of Asahi ICI Fluoropolymers Co., Ltd., the Fluon D-1 and D-2 of Daikin Industries, Ltd. and the Teflon (registered trademark) 30J of Du Pont-Mitsui Fluorochemicals Co., Ltd.

The PTFE mixture is obtained by (1) mixing together an aqueous dispersion of PTFE and an aqueous dispersion or solution of an organic polymer to carry out co-precipitation so as to obtain a coaggregated mixture (the method disclosed by JP-A 60-258263 and JP-A 63-154744), (2) mixing together an aqueous dispersion of PTFE and dried organic polymer particles (the method disclosed by JP-A 4-272957), (3) mixing together an aqueous dispersion of PTFE and a solution of organic polymer particles uniformly and removing the media from the mixture at the same time (the method disclosed by JP-A 06-220210 and JP-A 08-188653), (4) polymerizing a monomer forming an organic polymer in an aqueous dispersion of PTFE (the method disclosed by JP-A 9-95583) and (5) mixing together an aqueous dispersion of PTFE and a dispersion of an organic polymer uniformly and further polymerizing a vinyl-based monomer in the mixed dispersion to obtain a mixture (the method disclosed by JP-A 11-29679). Commercially available products of the PTFE mixture include the Metabrene A series typified by Metabrene A3000 (trade name), Metabrene A3700 (trade name) and Metabrene A3800 (trade name) of Mitsubishi Rayon Co., Ltd., the POLY TS AD001 (trade name) of PIC Co., Ltd. and the BLENDEX B449 (trade name) of GE Specialty-Chemicals Co., Ltd.

The content of the component C in the resin composition of the present invention is 0.01 to 6 parts by weight, preferably 0.1 to 3 parts by weight, more preferably 0.2 to 1 part by weight based on 100 parts by weight of the aromatic polycarbonate resin (component A).

### (Component D: Reinforcing Filler)

The resin composition of the present invention may be mixed with at least one reinforcing filler selected from the group consisting of a fibrous inorganic filler (component D-1) and a lamellar inorganic filler (component D-2) as the reinforcing filler (component D). The reinforcing filler is selected from a silicate mineral-based filler, a glass-based filler and a carbon fiber-based filler. Preferred examples of the silicate mineral-based filler include talc, micas such as muscovite mica and synthetic fluorine mica, smectite and wollastonite. Examples of the glass-based filler include glass fibers such as glass short fibers, glass flakes and glass milled fibers. The silicate mineral-based filler and the glass-based filler may be coated with a metal oxide such as titanium oxide, zinc oxide, cerium oxide or silicon oxide. Examples of the carbon fiber-based filler include carbon fibers such as metal coated carbon fibers, carbon milled fibers and vapor-grown carbon fibers, and carbon nanotubes. Out of these, at least one fibrous inorganic filler selected from the group consisting of glass fibers, glass milled fibers, wollastonite and carbon fibers is preferred as the component D-1. At least one lamellar inorganic filler selected from the group consisting of glass flakes, mica and talc is preferred as the component D-2.

The reinforcing filler (component D) may be surface treated with a surface treating agent. Examples of the surface treating agent include silane coupling agents (such as alkylalkoxysilanes and polyorganohydrogen siloxanes), higher fatty acid esters, acid compounds (such as phosphorous acid, phosphoric acid, carboxylic acid and carboxylic anhydride) and wax. Further, it may be granulated with greige goods such as resins including an olefin-based resin, styrene-based resin, acrylic resin, polyester-based resin, epoxy-based resin and urethane-based resin, higher fatty acid esters and wax to obtain granules.

The content of the reinforcing filler (component D) is preferably 1 to 50 parts by weight, more preferably 1 to 30 parts by weight, much more preferably 5 to 20 parts by weight based on 100 parts by weight of the aromatic polycarbonate resin (component A).

When the reinforcing filler (component D) is contained in the aromatic polycarbonate resin (component A), in general, the obtained resin composition deteriorates in heat stability and when it is heated, its molecular weight tends to lower. However, as the resin composition of the present invention contains a flame retardant obtained by introducing a sulfonic acid group and/or a sulfonic acid base into an aromatic polymer in an amount of 0.1 to 2.5 wt % in terms of sulfur as the flame retardant (component B), it has high heat stability.

When a glass-based filler such as glass fibers, glass short fibers or glass flakes is contained as the reinforcing filler (component D), a resin composition having high heat stability is obtained.

### (Component E: Ground Product of Optical Disk)

The resin composition of the present invention may contain a ground product of an optical disk (component E). The ground product of an optical disk is obtained by grinding a waste optical disk such as a defective product, a returned product or a collected product produced from all possible routes from production to sales of an optical disk. The ground product of an optical disk (component E) is preferably a ground product of an optical disk having a substrate essentially composed of an aromatic polycarbonate resin.

Examples of the optical disk include CD's (Compact Discs) such as CD-R and CR-RW, MO's, digital video disks, DVD's (Digital Versatile Discs) typified by DVD-ROM, DVD-Audio, DVD-R and DVD-RAM, BD's (Blu-ray Discs) and HD DVD's, and large-capacity optical disks such as holographic memories and near-field optical memories having an extremely large recording capacity.

Out of these, ground products of CD, DVD, BD and HD DVD are preferred, and ground products of CD and/or DVD are more preferred.

The ground product of the optical disk is preferably a ground product of an optical disk prepared by the following method. That is, after an aluminum film, ink and a UV coating film adhered to the surface of a compact disk, for example, are removed, the compact disk is ground to prepare the ground product. To remove the aluminum film, ink and UV coating film, a physical process such as a process for cutting or polishing the surface of the compact disk or a method of vibrating and compressing the compact disk, or a chemical method using an acid or alkali is employed.

Means of grinding a resin substrate is not particularly limited, and ordinary means for grinding a plastic plate is used. An example of the means is a cutting type or hammer type grinder. A cutting type grinder is preferably used because the amount of fine powders produced is small. A grinder having a rotary blade and a fixed blade and a round-hole screen in a lower part is preferably used, and only fine pieces of the resin substrate which can pass through the screen producing few fine powders can be obtained from the resin substrate by using this. Fine pieces of the ground resin substrate may be uniform or random in shape and size. The sizes of the fine pieces are such that the fine pieces substantially pass through round holes having a diameter of 15 mm and 90 wt % of the fine pieces does not pass through round holes having a diameter of 2 mm.

Preferably, the substrate of the optical disk is essentially composed of an aromatic polycarbonate resin. The amount of the aromatic polycarbonate resin in the optical disk is preferably not less than 90 wt %, more preferably not less than 95 wt %, much more preferably not less than 99 wt % based on 100 wt % of the optical disk.

The aromatic polycarbonate resin used in the substrate of the optical disk is generally obtained by reacting a diphenol with a carbonate precursor by a solution process or a melt process. Examples of the diphenol used herein include hydroquinone, resorcinol, 4,4′-biphenol, bis(4-hydroxyphenyl)methane, 1,1-bis(4-hydroxyphenyl)ethane, 2,2-bis(4-hydroxyphenyl)propane (to be referred to as “bisphenol A” hereinafter), 2,2-bis(3-methyl-4-hydroxyphenyl)propane, 2,2-bis(3,5-dimethyl-4-hydroxyphenyl)propane, 2,2-bis(4-hydroxyphenyl)butane, 1,1-bis(4-hydroxyphenyl)-1-phenylethane, 1,1-bis(4-hydroxyphenyl)cyclohexane, 1,1-bis(4-hydroxyphenyl)-3,3,5-trimethylcyclohexane, 2,2-bis(4-hydroxyphenyl)pentane, 4,4′-(m-phenylenediisopropylidene)diphenol, 4,4′-(p-phenylenediisopropylidene)diphenol, 9,9-bis(4-hydroxyphenyl)fluorene, 1,1-bis(4-hydroxyphenyl)-4-isopropylcyclohexane, bis(4-hydroxyphenyl)ether, bis(4-hydroxyphenyl)sulfide and bis(4-hydroxyphenyl)sulfone. Out of these, 2,2-bis(4-hydroxyphenyl)alkanes are preferred, and bisphenol A is particularly preferred.

The carbonate precursor is a carbonyl halide, carbonate ester or haloformate, as exemplified by phosgene, diphenyl carbonate and dihaloformates of a diphenol.

For the manufacture of the aromatic polycarbonate resin, diphenols may be used alone or in combination of two or more, and a molecular weight control agent, an antioxidant and a catalyst may be optionally used. The aromatic polycarbonate resin may be a branched polycarbonate resin obtained by copolymerizing a polyfunctional aromatic compound having 3 or more functional groups, or a mixture of two or more aromatic polycarbonate resins. The viscosity average molecular weight (M) of the aromatic polycarbonate resin used in the substrate of the optical disk is 1.0×10⁵ to 3.0×10⁵, preferably 1.2×10⁵ to 2.0×10⁵, more preferably 1.4×10⁵ to 1.6×10⁵.

The content of the ground product of the optical disk (component E) is preferably 1 to 100 parts by weight, more preferably 5 to 50 parts by weight, much more preferably 10 to 30 parts by weight based on 100 parts by weight of the component A.

Since the ground product of the optical disk (component E) has the same chemical structure as that of the aromatic polycarbonate resin (component A), the component E contained in the resin composition has an advantage that the environmental load can be reduced without changing the physical properties of the resin composition.

### (Other Additives)

The resin composition of the present invention may be mixed with additives which are generally mixed with a polycarbonate resin besides the components A to E.

### (I) Phosphorus-Based Stabilizer

The resin composition of the present invention is preferably mixed with a phosphorus-based stabilizer to such an extent that its hydrolyzability is not promoted. The phosphorus-based stabilizer improves the heat stability at the time of production or molding and the mechanical properties, color and molding stability of the resin composition. The phosphorus-based stabilizer is selected from phosphorous acid, phosphoric acid, phosphonous acid, phosphonic acid and esters thereof, and a tertiary phosphine.

Examples of the phosphite compound include triphenyl phosphite, tris(nonylphenyl)phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, 2,2-methylenebis(4,6-di-tert-butylphenyl)octyl phosphite, tris(diethylphenyl)phosphite, tris(di-iso-propylphenyl)phosphite, tris(di-n-butylphenyl)phosphite, tris(2,4-di-tert-butylphenylphoshite, tris(2,6-di-tert-butylphenyl)phosphite, distearyl pentaerythritol diphosphite, bis(2,4-di-tert-butylphenyl)pentaerythritol diphosphite, bis(2,6-di-tert-butyl-4-methylphenyl)pentaerythritol diphosphite, bis(2,6-di-tert-butyl-4-ethylphenyl)pentaerythritol diphosphite, phenyl bisphenol A pentaerythritol diphosphite, bis(nonylphenyl)pentaerythritol diphosphite and dicyclohexyl pentaerythritol diphosphite.

Other phosphite compounds which react with a diphenol and have a cyclic structure may also be used. The phosphite compounds include
2,2′-methylenebis(4,6-di-tert-butylphenyl)(2,4-di-tert-butylphenyl)phosphite,
2,2′-methylenebis(4,6-di-tert-butylphenyl)(2-tert-butyl-4-methylphenyl)phosphite,
2,2′-methylenebis(4-methyl-6-tert-butylphenyl)(2-tert-butyl-4-methylphenyl)phosphite and
2,2′-ethylidenebis(4-methyl-6-tert-butylphenyl)(2-tert-butyl-4-methylphenyl)phosphite.

Examples of the phosphate compound include tributyl phosphate, trimethyl phosphate, tricresyl phosphate, triphenyl phosphate, trichlorophenyl phosphate, triethyl phosphate, diphenylcresyl phosphate, diphenylmonoorthoxenyl phosphate, tributoxyethyl phosphate, dibutyl phosphate, dioctyl phosphate and diisopropyl phosphate, out of which triphenyl phosphate and trimethyl phosphate are preferred.

Examples of the phosphonite compound include tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, tetrakis(2,6-di-tert-butylphenyl)-4,4′-biphenylene diphosphonite, tetrakis(2,6-di-tert-butylphenyl)-4,3′-biphenylene diphosphonite, tetrakis(2,6-di-tert-butylphenyl)-3,3′-biphenylene diphosphonite, bis(2,4-di-tert-butylphenyl)-4-phenyl-phenyl phosphonite, bis(2,4-di-tert-butylphenyl)-3-phenyl-phenyl phosphonite, bis(2,6-di-n-butylphenyl)-3-phenyl-phenyl phosphonite, bis(2,6-di-tert-butylphenyl)-4-phenyl-phenyl phosphonite and bis(2,6-di-tert-butylphenyl)-3-phenyl-phenyl phosphonite, out of which tetrakis(di-tert-butylphenyl)-biphenylene diphosphonites and bis(di-tert-butylphenyl)-phenyl-phenyl phosphonites are preferred, and tetrakis(2,4-di-tert-butylphenyl)-biphenylene diphosphonite and bis(2,4-di-tert-butylphenyl)-phenyl-phenyl phosphonite are more preferred. The phosphonite compound is preferably used in combination with the above phosphite compound having an aryl group with two or more alkyl substituents.

Examples of the phosphonate compound include dimethylbenzene phosphonate, diethylbenzene phosphonate and dipropylbenzene phosphonate.

Examples of the tertiary phosphine include triethyl phosphine, tripropyl phosphine, tributyl phosphine, trioctyl phosphine, triamyl phosphine, dimethylphenyl phosphine, dibutylphenyl phosphine, diphenylmethyl phosphine, diphenyloctyl phosphine, triphenyl phosphine, tri-p-tolyl phosphine, trinaphthyl phosphine and diphenylbenzyl phosphine. Triphenyl phosphine is particularly preferred as the tertiary phosphine.

The above phosphorus-based stabilizers may be used alone or in combination of two or more. Out of these phosphorus-based stabilizers, alkyl phosphate compounds typified by trimethyl phosphate are preferably used. A combination of an alkylphosphate compound and a phosphite compound and/or a phosphonite compound is also preferred.

### (II) Hindered Phenol-Based Stabilizer

The resin composition of the present invention may be further mixed with a hindered phenol-based stabilizer. When a hindered phenol-based stabilizer is used, it produces the effect of suppressing the deterioration of color at the time of molding or after long-time use. Examples of the hindered phenol-based stabilizer include α-tocopherol, butylhydroxytoluene, sinapyl alcohol, vitamin E, n-octadecyl-β-(4′-hydroxy-3′,5′-di-tert-butylphenyl) propionate, 2-tert-butyl-6-(3′-tert-butyl-5′-methyl-2′-hydroxybenzyl)-4-methylphenyl acrylate, 2,6-di-tert-butyl-4-(N,N-dimethylaminomethyl)phenol, 3,5-di-tert-butyl-4-hydroxybenzylphosphonate diethyl ester, 2,2′-methylenebis(4-methyl-6-tert-butylphenol), 2,2′-methylenebis(4-ethyl-6-tert-butylphenol), 4,4′-methylenebis(2,6-di-tert-butylphenol), 2,2′-methylenebis(4-methyl-6-cyclohexylphenol), 2,2′-dimethylene-bis(6-α-methyl-benzyl-p-cresol), 2,2′-ethylidene-bis(4,6-di-tert-butylphenol), 2,2′-butylidene-bis(4-methyl-6-tert-butylphenol), 4,4′-butylidene-bis(3-methyl-6-tert-butylphenol), triethylene glycol-N-bis-3-(3-tert-butyl-4-hydroxy-5-methylphenyl) propionate, 1,6-hexanediol-bis[3-(3,5-di-tert-butyl-4-hydroxyphenyl) propionate], bis[2-tert-butyl-4-methyl-6-(3-tert-butyl-5-methyl-2-hydroxybenzyl)phenyl]terephthalate, 3,9-bis{2-[3-(3-tert-butyl-4-hydroxy-5-methylphenyl) propionyloxy]-1,1-dimethylethyl}-2,4,8,10-tetraoxaspiro[5,5]undecane, 4,4′-thiobis(6-tert-butyl-m-cresol), 4,4′-thiobis(3-methyl-6-tert-butylphenol), 2,2′-thiobis(4-methyl-6-tert-butylphenol), bis(3,5-di-tert-butyl-4-hydroxybenzyl)sulfide, 4,4′-di-thiobis(2,6-di-tert-butylphenol), 4,4′-tri-thiobis(2,6-di-tert-butylphenol), 2,2-thiodiethylenebis-[3-(3,5-di-tert-butyl-4-hydroxyphenyl)propionate], 2,4-bis(n-octylthio)-6-(4-hydroxy-3′,5′-di-tert-butylanilino)-1,3,5-triazine, N,N′-hexamethylenebis-(3,5-di-tert-butyl-4-hydroxyhydrocinnamide), N,N′-bis[3-(3,5-di-tert-butyl-4-hydroxyphenyl)propionyl]hydrazine, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, tris(3,5-di-tert-butyl-4-hydroxyphenyl) isocyanurate, tris(3,5-di-tert-butyl-4-hydroxybenzyl) isocyanurate, 1,3,5-tris(4-tert-butyl-3-hydroxy-2,6-dimethylbenzyl) isocyanurate, 1,3,5-tris-2 [3 (3,5-di-tert-butyl-4-hydroxyphenyl) propionyloxy]ethyl isocyanurate and tetrakis [methylene-3-(3′, 5′-di-tert-butyl-4-hydroxyphenyl)propionate]methane. All of them are easily acquired. The above hindered phenol-based stabilizers may be used alone or in combination of two or more.

The amount of the phosphorus-based stabilizer or the hindered phenol-based stabilizer is preferably 0.0001 to 1 part by weight, more preferably 0.001 to 0.5 part by weight, much more preferably 0.005 to 0.3 part by weight based on 100 parts by weight of the aromatic polycarbonate resin (component A).

### (III) Heat Stabilizer Except for the Above Components

The resin composition of the present invention may be mixed with another heat stabilizer except for the above phosphorus-based stabilizer and the hindered phenol-based stabilizer. A preferred example of the another heat stabilizer is a lactone-based stabilizer typified by a reaction product of 3-hydroxy-5,7-di-tert-butyl-furan-2-one and o-xylene. This stabilizer is detailed in JP-A 7-233160. This compound is marketed under the name of Irganox HP-136 (trademark, manufactured by Ciba Specialty Chemicals Co., Ltd.) and may be used. A stabilizer prepared by mixing together the above compound, a phosphite compound and a hindered phenol compound is commercially available. A preferred example of the stabilizer is the Irganox HP-2921 of Ciba Specialty Chemicals Co., Ltd. The amount of the lactone-based stabilizer is preferably 0.0005 to 0.05 part by weight, more preferably 0.001 to 0.03 part by weight based on 100 parts by weight of the aromatic polycarbonate resin (component A).

Other stabilizers include sulfur-containing stabilizers such as pentaerythritol tetrakis(3-mercaptopropionate), pentaerythritol tetrakis(3-laurylthiopropionate) and glycerol-3-stearyl thiopropionate. The amount of the sulfur-containing stabilizer is preferably 0.001 to 0.1 part by weight, more preferably 0.01 to 0.08 part by weight based on 100 parts by weight of the aromatic polycarbonate resin (component A).

### (IV) Ultraviolet Absorbent

An ultraviolet absorbent may be mixed with the resin composition of the present invention to provide light resistance.

Examples of the benzophenone-based ultraviolet absorbent include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2-hydroxy-4-methoxy-5-sulfoxytrihydriderate (??) benzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxy benzophenone, bis(5-benzoyl-4-hydroxy-2-methoxyphenyl)methane, 2-hydroxy-4-n-dodecyloxybenzophenone and 2-hydroxy-4-methoxy-2′-carboxybenzophenone.

Examples of the benzotriazole-based ultraviolet absorbent include 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylenebis[4-(1,1,3,3-tetramethylbutyl)-6-(2H-benzotriazol-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylenebis(4-cumyl-6-benzotriazolephenyl), 2,2′-p-phenylenebis(1,3-benzoxazin-4-one), 2-[2-hydroxy-3-(3,4,5,6-tetrahydrophthalimidomethyl)-5-methylphenyl]benzotriazole, and polymers having a 2-hydroxyphenyl-2H-benzotriazole skeleton such as a copolymer of 2-(2′-hydroxy-5-methacryloxyethylphenyl)-2H-benzotriazole and a vinyl-based monomer copolymerizable with that monomer and a copolymer of 2-(2′-hydroxy-5-acryloxyethylphenyl)-2H-benzotriazole and a vinyl-based monomer copolymerizable with that monomer.

Examples of the hydroxyphenyltriazine-based ultraviolet absorbent include
2-(4,6-diphenyl-1,3,5-triazin-2-yl)-5-hexyloxyphenol,
2-(4,6-diphenyl-1,3,5-triazin-2-yl)-5-methyloxyphenol,
2-(4,6-diphenyl-1,3,5-triazin-2-yl)-5-ethyloxyphenol,
2-(4,6-diphenyl-1,3,5-triazin-2-yl)-5-propyloxyphenol and
2-(4,6-diphenyl-1,3,5-triazin-2-yl)-5-butyloxyphenol. Further, compounds having a 2,4-dimethylphenyl group in place of the phenyl groups of the above compounds such as 2-(4,6-bis(2,4-dimethylphenyl)-1,3,5-triazin-2-yl)-5-hexyloxyphenol are also included.

Examples of the cyclic iminoester-based ultraviolet absorbent include
2,2′-p-phenylenebis(3,1-benzoxazin-4-one),
2,2′-m-phenylenebis(3,1-benzoxazin-4-one) and
2,2′-p-diphenylenebis(3,1-benzoxazin-4-one).

Examples of the cyanoacrylate-based ultraviolet absorbent include
1,3-bis[(2′-cyano-3′,3′-diphenylacryloyl)oxy]-2,2-bis[(2-cyano-3,3-diphenylacryloyl)oxy]methyl)propane and
1,3-bis-[(2-cyano-3,3-diphenylacryloyl)oxy]benzene.

The above ultraviolet absorbent may be a polymer type ultraviolet absorbent obtained by copolymerizing an ultraviolet absorbing monomer and/or an optically stable monomer which has the structure of a monomer compound able to be radically polymerized with a monomer such as an alkyl (meth)acrylate. The above ultraviolet absorbing monomer is preferably a compound having a benzotriazole skeleton, a benzophenone skeleton, a triazine skeleton, a cyclic iminoester skeleton or a cyanoacrylate skeleton in the ester substituent of a (meth)acrylic acid ester.

Out of these, benzotriazole-based and hydroxyphenyltriazine-based compounds are preferred from the viewpoint of ultraviolet absorbing ability, and cyclic imionoester-based and cyanoacrylate-based compounds are preferred from the viewpoints of heat resistance and color. The above ultraviolet absorbents may be used alone or in combination of two or more.

The amount of the ultraviolet absorbent is preferably 0.01 to 2 parts by weight, more preferably 0.02 to 2 parts by weight, much more preferably 0.03 to 1 part by weight, particularly preferably 0.05 to 0.5 part by weight based on 100 parts by weight of the aromatic polycarbonate resin (component A).

### (V) Another Resin and Elastomer

A small amount of another resin or an elastomer may be used in the resin composition of the present invention in place of part of the aromatic polycarbonate resin as the component A as long as the effect of the present invention is obtained. The amount of the another resin or the elastomer is preferably not more than 20 wt %, more preferably not more than 10 wt %, much more preferably not more than 5 wt % based on 100 wt % of the total of it and the aromatic polycarbonate resin (component A).

Examples of the another resin include polyester resins such as polyethylene terephthalate and polybutylene terephthalate, polyamide resins, polyimide resins, polyether imide resins, polyurethane resins, silicone resins, polyphenylene ether resins, polyphenylene sulfide resins, polysulfone resins, polyolefin resins such as polyethylene and polypropylene, polystyrene resins, acrylonitrile/styrene copolymer (AS resin), acrylonitrile/butadiene/styrene copolymer (ABS resin), polymethacrylate resins, phenolic resins and epoxy resins.

Examples of the elastomer include isobutylene/isoprene rubber, styrene/butadiene rubber, ethylene/propylene rubber, acrylic elastomers, polyester-based elastomers, polyamide-based elastomers, core-shell type elastomers such as MBS (methyl methacrylate/styrene/butadiene) rubber and MAS (methyl methacrylate/acrylonitrile/styrene) rubber.

### (VI) Other Components

Small amounts of additives known per se may be mixed with the resin composition of the present invention to provide various functions to a molded product of the resin composition and improve the characteristics properties of the molded product, besides the above components. These additives are used in normal amounts as long as the object of the present invention is not impaired.

The additives include a sliding agent (such as PTFE particles), a colorant (pigment or dye such as carbon black or titanium oxide), a light diffusing agent (such as acrylic crosslinked particles, silicone crosslinked particles or calcium carbonate particles), a fluorescent dye, a fluorescent brightener, an optical stabilizer (typified by a hindered amine compound), an inorganic phosphor (such as a phosphor containing an aluminate as a mother crystal), an antistatic agent, a crystal nucleating agent, inorganic and organic antibacterial agents, an optical catalyst-based antifouling agent (such as particulate titanium oxide or particulate zinc oxide), a release agent, a flowability modifier, a radical generator, an infrared absorbent (heat-ray absorbent) and a photochromic agent.

### <Process of Producing Resin Composition>

The resin composition of the present invention can be produced by mixing together 100 parts by weight of the aromatic polycarbonate resin (component A), 0.001 to 8 parts by weight of the flame retardant (component B) and 0.01 to 6 parts by weight of the fluorine-containing dripping inhibitor (component C).

To disperse the fluorine-containing dripping inhibitor well, the above components are preferably melt kneaded together by means of a multi-screw extruder such as a double-screw extruder.

A typical example of the double-screw extruder is ZSK (of Werner & Pfleiderer Co., Ltd., trade name). Examples of the similar type double-screw extruder include TEX (of The Japan Steel Works, Ltd., trade name), TEM (of Toshiba Machine Co., Ltd., trade name), and KTX (of Kobe Steel Ltd., trade name). Melt kneaders such as FCM (of Farrel Co., Ltd., trade name), Ko-Kneader (of Buss Co., Ltd., trade name) and DSM (of Krauss-Maffei Co., Ltd., trade name) may also be used. Out of these, a ZSK type double-screw extruder is more preferred. In the ZSK type double-screw extruder, the screws are of a completely interlocking type and consist of screw segments which differ in length and pitch and kneading disks which differ in width (or kneading segments corresponding to these).

A preferred example of the double-screw extruder is as follows. As for the number of screws, one, two or three screws may be used, and two screws can be preferably used because they have wide ranges of molten resin conveyance capacity and shear kneading capacity. The ratio (L/D) of the length (L) to the diameter (D) of each screw of the double-screw extruder is preferably 20 to 45, more preferably 28 to 42. When L/D is large, homogeneous dispersion is easily attained and when L/D is too large, the decomposition of the resin readily occurs by heat deterioration. The screw must have at least one, preferably one to three kneading zones, each composed of a kneading disk segment (or a kneading segment corresponding to this) in order to improve kneadability.

Further, an extruder having a vent from which water contained in the raw material and a volatile gas generated from the molten kneaded resin can be removed may be preferably used. A vacuum pump is preferably installed to discharge the generated water and volatile gas to the outside of the extruder from the vent efficiently. A screen for removing foreign matter contained in the extruded raw material may be installed in a zone before the dice of the extruder to remove the foreign matter from the resin composition. Examples of the screen include a metal net, a screen changer and a sintered metal plate (such as a disk filter).

Further, the method of supplying the components B to E and the additives (to be simply referred to as “additives” in the following examples) into the extruder is not particularly limited. The following methods are typical examples of the method: (i) one in which the additives are supplied into an extruder separately from the polycarbonate resin, (ii) one in which the additives and the polycarbonate resin powders are pre-mixed together by means of a mixer such as a super mixer and supplied into the extruder, and (iii) one in which the additives and the polycarbonate resin are melt kneaded together in advance to prepare a master pellet.

One example of the method (ii) is to pre-mix together all the necessary raw materials and supply the resulting mixture into the extruder. Another example of the method is to prepare a master agent which contains the additives in high concentrations and supply the master agent into the extruder independently or after it is pre-mixed with the remaining polycarbonate resin. The master agent may be in the form of a powder or a granule prepared by compacting and granulating the powder. Other pre-mixing means include a Nauter mixer, a twin-cylinder mixer, a Henschel mixer, a mechanochemical device and an extrusion mixer. Out of these, a high-speed agitation type mixer such as a super mixer is preferred. Another pre-mixing method is to uniformly disperse the polycarbonate resin and the additives in a solvent so as to prepare a solution and remove the solvent from the solution.

The resin extruded from the extruder is pelletized by directly cutting it or by forming it into a strand and cutting the strand by a pelletizer. When the influence of extraneous dust must be reduced, the atmosphere surrounding the extruder is preferably made clean. In the manufacture of the above pellet, it is possible to narrow the form distribution of pellets, reduce the number of miscut products, reduce the amount of fine powders generated at the time of conveyance or transportation and cut the number of cells (vacuum cells) formed in the strand or pellet by using various methods already proposed for polycarbonate resins for use in optical disks. Thereby, it is possible to increase the molding cycle and reduce the incidence of a defect such as a silver streak. The shape of the pellet may be columnar, rectangular column-like, spherical or other common shape, preferably columnar. The diameter of the column is preferably 1 to 5 mm, more preferably 1.5 to 4 mm, much more preferably 2 to 3.3 mm. The length of the column is preferably 1 to 30 mm, more preferably 2 to 5 mm, much more preferably 2.5 to 3.5 mm.

### <Molded Article>

Various products can be generally manufactured from the resin composition of the present invention by injection molding a pellet manufactured as described above. The resin which has been melt kneaded by means of an extruder may be directly molded into a sheet, a film, an odd-shaped extrusion molded article, a direct blow molded article or an injection molded article without being pelletized.

Molded articles can be obtained not only by ordinary molding techniques but also by injection molding techniques such as injection compression molding, injection press molding, gas assist injection molding, foam molding (including what comprises the injection of a super-critical fluid), insert molding, in-mold coating molding, insulated runner molding, quick heating and cooling molding, two-color molding, sandwich molding and super high-speed injection molding according to purpose. The advantages of these molding techniques are already widely known. Both cold-runner molding and hot-runner molding techniques may also be employed.

The resin composition of the present invention may be formed into an odd-shaped molded article, a sheet or a film by extrusion molding. Inflation, calendering and casting techniques may also be used to mold a sheet or a film. Further, specific drawing operation may be used to mold it into a heat shrinkable tube. The resin composition of the present invention can be formed into a molded article by rotational molding or blow molding.

Thereby, there is provided a molded article of the polycarbonate resin composition having excellent flame retardancy, heat resistance and stiffness. That is, according to the present invention, there is provided a molded article by melt molding a resin composition which comprises 100 parts by weight of an aromatic polycarbonate resin (component A), 0.001 to 8 parts by weight of a flame retardant (component B) and 0.01 to 6 parts by weight of a fluorine-containing dripping inhibitor (component C), wherein

the flame retardant (component B) is obtained by introducing a sulfonic acid group and/or a sulfonic acid base into an aromatic polymer in an amount of 0.1 to 2.5 wt % in terms of sulfur.

Further, the molded article of the resin composition of the present invention can be subjected to various surface treatments. The surface treatments as used herein include deposition (physical deposition, chemical deposition, etc.), plating (electroplating, electroless plating, hot dipping, etc.), painting, coating and printing, all of which are employed to form a new layer on the surface layer of a resin molded article, and can be applied to ordinary polycarbonate resins. Specific examples of the surface treatments include hard coating, water repellent and oil repellent coating, ultraviolet light absorption coating, infrared light absorption coating and metallizing (such as deposition).

### EXAMPLES

The following examples are provided to further illustrate the present invention. Evaluations were made by the following methods.

### (1) Heat Stability: Molecular Weight Loss (ΔMv)

After the obtained pellet was dried at 120° C. for 6 hours with a hot air drier, the viscosity average molecular weight (M₁) of the pellet was measured by the method described in this text.

Then, a 2 mm-thick plate (length of 40 mm, width of 50 mm) was molded at a cylinder temperature of 280° C. and a mold temperature of 80° C. with an injection molding machine (SG-150U of Sumitomo Heavy Industries, Ltd.). After plates were continuously molded from 20 shots of the resin and metering was completed, an injection cylinder was moved back so that the molten resin was kept in the cylinder for 10 minutes. After the residence, 4 shots of the resin were molded again under the same conditions. The viscosity average molecular weight (M₂) of a molded product obtained from a fourth-shot of the resin after the residence was measured likewise.

A value obtained by subtracting the molecular weight (M₂) after the residence from the molecular weight (M₁) of the pellet was evaluated as ΔMv. It can be said that as ΔMv is smaller, heat stability becomes higher.

### (2) Flame Retardancy

A UL94 vertical combustion test was made at a thickness of 1.6 mm and a thickness of 2.0 mm to rate the flame retardancy.

### (3) Heat Resistance

A test sample was formed by injection molding and its deflection temperature under load was measured at 1.80 MPa in accordance with ISO 75-1 and 75-2.

### (4) Charpy Impact Strength

The notched Charpy impact strength of the sample was measured in accordance with ISO179.

### (5) Stiffness

The flexural modulus of the sample was measured in accordance with ISO178 (sample size: length of 80 mm, width of 10 mm, thickness of 4 mm).

### Examples 1 to 27 and Comparative Examples 1 to 16

Additives shown in Tables 1 and 2 were added in amounts shown in Tables 1 and 2 to polycarbonate resin powders produced from bisphenol A and phosgene by the interfacial condensation process, mixed by means of a blender and melt kneaded by means of a vented double extruder ((TEX30α of The Nippon Steel Works, Ltd. (completely interlocking type, same-direction rotation, two screws)) to obtain a pellet. After a pre-mixture of the additives excluding the component E and the aromatic polycarbonate powders was prepared by means of a Henschel mixer to ensure that the concentrations of the additives were 10 times the above amounts thereof, it was wholly mixed by means of a blender. As for extrusion conditions, the delivery rate was 20 kg/h, the screw revolution was 150 rpm, the vacuum degree of the vent was 3 kPa, and the extrusion temperature from the first supply port to the dice was 260° C.

The obtained pellet was dried at 120° C. for 6 hours with a hot air circulation type drier and molded into test samples for the measurement of flame retardancy, deflection temperature under load, Charpy impact strength and flexural modulus at the same time at a cylinder temperature of 290° C. and a mold temperature of 80° C. and an injection rate of 50 mm/sec by means of an injection molding machine. An injection molding machine (SG-150U of Sumitomo Heavy Industries, Ltd.) was used.

Symbols in Tables 1 and 2 denote the following compounds.

### (Component A)

PC-1: linear aromatic polycarbonate resin powders synthesized from bisphenol A, p-tert-butylphenol as a terminal capping agent and phosgene by the interfacial polycondensation process (Panlite L-1225WP (trade name) of Teijin Chemicals Ltd., viscosity average molecular weight of 22,400)
PC-2: linear aromatic polycarbonate resin powders synthesized from bisphenol A, p-tert-butylphenol as a terminal capping agent and phosgene by the interfacial polycondensation process (L-1225WX (trade name) of Teijin Chemicals Ltd., viscosity average molecular weight of 20, 900)
PC-3: polycarbonate resin pellet having a branched bond component in an amount of about 0.1 mol % based on the total of all the recurring units, which is obtained from bisphenol A and diphenyl carbonate through a melt transesterification reaction (viscosity average molecular weight of 22,500, the content of the branched bond component was calculated by ¹H-NMR measurement, and that of the polycarbonate resin PC-1 measured likewise was 0 mol % (no peak))

### (Component B)

B-1: potassium metal salt of polystyrenesulfonic acid (the introduction rate of a sulfonic acid group and/or a sulfonic acid base into an aromatic polymer is 1.44% in terms of sulfur)
B-2: potassium metal salt of polystyrenesulfonic acid (the introduction rate of a sulfonic acid group and/or a sulfonic acid base into an aromatic polymer is 2.14% in terms of sulfur)
B-3: potassium metal salt of acrylonitrile styrenesulfonic acid (the introduction rate of a sulfonic acid group and/or a sulfonic acid base into an aromatic polymer is 2.24% in terms of sulfur)
B-4: sodium metal salt of polystyrenesulfonic acid (the introduction rate of a sulfonic acid group and/or a sulfonic acid base into an aromatic polymer is 1.18% in terms of sulfur)
(Comparative component B)
B-5: mixture of a dipotassium salt of diphenylsulfone-3,3′-disulfonic acid and a potassium salt of diphenylsulfone-3-monosulfonic acid in a ratio of 2:8 (KSS (trade name) of UCB Japan Co., Ltd.)
B-6: potassium metal salt of perfluorobutanesulfonic acid (Megafac F-114P (trade name) of Dainippon Ink and Chemicals, Inc.)
B-7: phosphate comprising bisphenol A bis(diphenylphosphate) as the main component (CR-741 (trade name) of Daihachi Chemical Industry Co., Ltd.)

### (Component C)

C-1: Polyfuron MPA FA500 (trade name) (of Daikin Industries, Ltd., polytetrafluoroethylene)
C-2: POLY TS AD001 (trade name) (of PIC Co., Ltd., the polytetrafluoroethylene-based mixture is a mixture of polytetrafluoroethylene powders and styrene-acrylonitrile copolymer powders (content of polytetrafluoroethylene is 50 wt %))

### (Component D)

D-1: ECS-03T-511 (trade name) (glass fiber of Nippon Electric Glass Co., Ltd., diameter of 13 μm, cut length of 3 mm)
D-2: PEF-301S (trade name) (glass milled fiber of Nitto Boseki Co., Ltd., diameter of 9 μm, number average fiber length of 30 μm)
D-3: Upn HS-T0.8 (trade name) (talc of Hayashi-Kasei Kogyo Co., Ltd., lamellar, average particle diameter of 2 μm)

### (Component E)

E-1: ground product of an optical disk having an average particle diameter of 6 mm obtained by grinding a 120 mm-diameter CD from which an aluminum film etc. was removed by means of a grinder (the substrate was molded from an aromatic polycarbonate resin obtained from bisphenol A and having a viscosity average molecular weight of 15,000, and the content of the resin was 99.6 wt % of the total weight of the CD)
E-2: ground product of an optical disk having an average particle diameter of 6 mm obtained by grinding a 120 mm-diameter DVD from which a metal film etc. was removed by means of a grinder (the substrate was molded from an aromatic polycarbonate resin obtained from bisphenol A and having a viscosity average molecular weight of 15,000, and the content of the resin was 92.0 wt % of the total weight of the DVD)

### (Others)

SL: Rikemal SL900 (trade name) (saturated fatty acid ester-based release agent of Riken Vitamin Co., Ltd.)
TMP: TMP (trade name) (phosphorus-based stabilizer of Daihachi Chemical Industry Co., Ltd.)

TABLE 1

| | | | Unit | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|---|
| Composition | Component A | PC-1 | Parts by | | | | | | | | | |
| | | PC-2 | weight | 100 | 100 | 100 | 100 | 100 | 100 | 100 | 100 | 100 |
| | | PC-3 | | | | | | | | | | |
| | Component B | B-1 | | 0.1 | 0.3 | 0.3 | 0.3 | 0.3 | 0.3 | 0.1 | 0.3 | 0.1 |
| | | B-2 | | | | | | | | | | |
| | | B-3 | | | | | | | | | | |
| | | B-4 | | | | | | | | | | |
| | Comparative | B-5 | | | | | | | | 0.1 | 0.3 | |
| | component B | B-6 | | | | | | | | | | 0.3 |
| | | B-7 | | | | | | | | | | |
| | Component C | C-1 | | 0.4 | 0.4 | | 0.4 | 0.4 | 0.4 | 0.4 | 0.4 | 0.4 |
| | | C-2 | | | | 0.8 | | | | | | |
| | Component E | E-1 | | | | | 50 | 100 | | | | |
| | | E-2 | | | | | | | 100 | | | |
| | Others | SL | | 0.2 | 0.2 | 0.2 | 0.2 | 0.2 | 0.2 | 0.2 | 0.2 | 0.2 |
| | | TMP | | 0.02 | 0.02 | 0.02 | 0.02 | 0.02 | 0.02 | 0.02 | 0.02 | 0.02 |
| Characteristic | Existence of halogen | | | None | None | None | None | None | None | None | None | None |
| properties | Flame | 1.6 mmt | — | V-0 | V-0 | V-0 | V-0 | V-0 | V-0 | V-0 | V-0 | V-1 |
| | retardancy | 2.0 mmt | — | V-0 | V-0 | V-0 | V-0 | V-0 | V-0 | V-0 | V-0 | V-0 |
| | Heat | deflection | ° C. | 127 | 127 | 127 | 127 | 127 | 127 | 127 | 127 | 127 |
| | resistance | temperature | | | | | | | | | | |
| | | under load | | | | | | | | | | |
| | Impact | Charpy | KJ/m² | 13 | 13 | 15 | 12 | 11 | 11 | 13 | 13 | 13 |
| | strength | impact | | | | | | | | | | |
| | | strength | | | | | | | | | | |
| | Stiffness | Flexural | MPa | 2350 | 2350 | 2350 | 2350 | 2300 | 2300 | 2350 | 2350 | 2350 |
| | | modulus | | | | | | | | | | |

| | | | Unit | Ex. 10 | Ex. 11 | Ex. 12 | Ex. 13 | Ex. 14 | Ex. 15 | Ex. 16 | Ex. 17 |
|---|---|---|---|---|---|---|---|---|---|---|---|
| Composition | Component A | PC-1 | Parts | | | | | | | 100 | |
| | | PC-2 | by | 100 | 100 | 100 | 100 | 100 | 100 | | 100 |
| | | PC-3 | weight | | | | | | | | |
| | Component B | B-1 | | 0.3 | | | | | | 0.3 | 0.3 |
| | | B-2 | | | 0.1 | 0.3 | | | | | |
| | | B-3 | | | | | 0.3 | | | | |
| | | B-4 | | | | | | 0.1 | 0.3 | | |
| | Comparative | B-5 | | | | | | | | | |
| | component B | B-6 | | | | | | | | | |
| | | B-7 | | 1 | | | | | | | |
| | Component C | C-1 | | 0.4 | 0.4 | 0.4 | 0.4 | 0.4 | 0.4 | 0.4 | 0.4 |
| | | C-2 | | | | | | | | | |
| | Component E | E-1 | | | | | | | | | |
| | | E-2 | | | | | | | | | |
| | Others | SL | | 0.2 | 0.2 | 0.2 | 0.2 | 0.2 | 0.2 | 0.2 | 0.2 |
| | | TMP | | 0.02 | 0.02 | 0.02 | 0.02 | 0.02 | 0.02 | 0.02 | 0.02 |
| Characteristic | Existence of halogen | | | None | None | None | None | None | None | None | None |
| properties | Flame | 1.6 mmt | — | V-0 | V-0 | V-0 | V-0 | V-0 | V-0 | V-0 | V-0 |
| | retardancy | 2.0 mmt | — | V-0 | V-0 | V-0 | V-0 | V-0 | V-0 | V-0 | V-0 |
| | Heat | deflection | ° C. | 122 | 127 | 127 | 127 | 127 | 127 | 128 | 128 |
| | resistance | temperature | | | | | | | | | |
| | | under load | | | | | | | | | |
| | Impact | Charpy | KJ/m² | 13 | 13 | 13 | 13 | 13 | 13 | 15 | 15 |
| | strength | impact | | | | | | | | | |
| | | strength | | | | | | | | | |
| | Stiffness | Flexural | MPa | 2300 | 2350 | 2350 | 2350 | 2350 | 2350 | 2300 | 2300 |
| | | modulus | | | | | | | | | |

| | | | | C. | C. | C. | C. | C. | C. | C. | C. | C. | C. |
|---|---|---|---|---|---|---|---|---|---|---|---|---|---|
| | | | Unit | Ex. 1 | Ex. 2 | Ex. 3 | Ex. 4 | Ex. 5 | Ex. 6 | Ex. 7 | Ex. 8 | Ex. 9 | Ex. 10 |
| Composition | Component | PC-1 | Parts | | | | | | | | | 100 | |
| | A | PC-2 | by | 100 | 100 | 100 | 100 | 100 | 100 | 100 | 100 | | |
| | | PC-3 | weight | | | | | | | | | | 100 |
| | Component | B-1 | | 0.3 | 10 | | | | | | | | |
| | B | B-2 | | | | | | | | | | | |
| | | B-3 | | | | | | | | | | | |
| | | B-4 | | | | | | | | | | | |
| | Comparative | B-5 | | | | 0.1 | 0.3 | 0.5 | | | | 0.3 | |
| | component B | B-6 | | | | | | | 0.3 | | | | 0.1 |
| | | B-7 | | | | | | | | 1 | 5 | | |
| | Component | C-1 | | | 0.4 | 0.4 | 0.4 | 0.4 | 0.4 | 0.4 | 0.4 | 0.4 | 0.4 |
| | C | C-2 | | | | | | | | | | | |
| | Component | E-1 | | | | | | | | | | | |
| | E | E-2 | | | | | | | | | | | |
| | Others | SL | | 0.2 | 0.2 | 0.2 | 0.2 | 0.2 | 0.2 | 0.2 | 0.2 | 0.2 | 0.2 |
| | | TMP | | 0.02 | 0.02 | 0.02 | 0.02 | 0.02 | 0.02 | 0.02 | 0.02 | 0.02 | 0.02 |
| Characteristic | Existence of halogen | | | None | None | None | None | None | Yes | None | None | None | Yes |
| properties | Flame | 1.6 mmt | — | V-2 | V-2 | V-1 | V-1 | V-2 | V-2 | V-1 | V-0 | V-1 | V-0 |
| | retardancy | 2.0 mmt | — | V-2 | V-2 | V-0 | V-0 | V-0 | V-0 | V-0 | V-0 | V-0 | V-0 |
| | Heat | deflection | ° C. | 127 | 127 | 127 | 127 | 127 | 127 | 122 | 102 | 128 | 128 |
| | resistance | temperature | | | | | | | | | | | |
| | | under load | | | | | | | | | | | |
| | Impact | Charpy | KJ/m² | 15 | 9 | 13 | 13 | 13 | 13 | 13 | 10 | 15 | 15 |
| | strength | impact | | | | | | | | | | | |
| | | strength | | | | | | | | | | | |
| | Stiffness | Flexural | MPa | 2350 | 2300 | 2350 | 2350 | 2350 | 2350 | 2300 | 2250 | 2300 | 2300 |
| | | modulus | | | | | | | | | | | |

Ex.: Example
C. Ex.: Comparative Example

TABLE 2

| | | | Unit | Ex. 18 | Ex. 19 | Ex. 20 | Ex. 21 | Ex. 22 | Ex. 23 | Ex. 24 | Ex. 25 | Ex. 26 | Ex. 27 |
|---|---|---|---|---|---|---|---|---|---|---|---|---|---|
| Composition | Component | PC-1 | Parts | | | | | | 100 | 100 | | | |
| | A | PC-2 | by | 100 | 100 | 100 | 100 | 100 | | | 100 | 100 | 100 |
| | Component | B-1 | weight | 0.3 | 0.5 | 0.5 | 0.5 | 0.5 | 0.5 | 0.5 | | | |
| | B | B-2 | | | | | | | | | 0.5 | | |
| | | B-3 | | | | | | | | | | 0.5 | |
| | | B-4 | | | | | | | | | | | 0.5 |
| | Comparative | B-5 | | | | | | | | | | | |
| | component B | B-6 | | | | | | | | | | | |
| | | B-7 | | | | | | | | | | | |
| | Component | C-1 | | 0.3 | 0.3 | 0.3 | 0.3 | 0.3 | 0.3 | 0.3 | 0.3 | 0.3 | 0.3 |
| | C | C-2 | | | | | | | | | | | |
| | Component | D-1 | | 10 | 10 | 15 | 15 | 15 | 15 | | 15 | 15 | 15 |
| | D | D-2 | | 10 | 10 | 15 | 15 | 15 | 15 | | 15 | 15 | 15 |
| | | D-3 | | | | | | | | 15 | | | |
| | Component | E-1 | | | 10 | | 10 | | 10 | 10 | 10 | 10 | 10 |
| | E | E-2 | | | | | | 10 | | | | | |
| | Others | SL | | 0.5 | 0.5 | 0.5 | 0.5 | 0.5 | 0.5 | 0.5 | 0.5 | 0.5 | 0.5 |
| | | TMP | | 0.02 | 0.02 | 0.02 | 0.02 | 0.02 | 0.02 | 0.02 | 0.02 | 0.02 | 0.02 |
| Characteristic | Existence of halogen | | | None | None | None | None | None | None | None | None | None | None |
| properties | Heat | ΔMv | — | 700 | 800 | 800 | 900 | 900 | 800 | 1100 | 900 | 900 | 900 |
| | stability | | | | | | | | | | | | |
| | Flame | 2.0 mmt | — | V-0 | V-0 | V-0 | V-0 | V-0 | V-0 | V-0 | V-0 | V-0 | V-0 |
| | retardancy | | | | | | | | | | | | |
| | Heat | Deflection | ° C. | 133 | 133 | 140 | 140 | 140 | 140 | 130 | 140 | 141 | 141 |
| | resistance | temperature | | | | | | | | | | | |
| | | under load | | | | | | | | | | | |
| | Impact | Charpy | KJ/m² | 7 | 7 | 8 | 8 | 8 | 8 | 13 | 8 | 8 | 8 |
| | strength | impact | | | | | | | | | | | |
| | | strength | | | | | | | | | | | |
| | Stiffness | Flexural | MPa | 4400 | 4400 | 6100 | 6100 | 6100 | 6100 | 4000 | 6100 | 6100 | 6100 |
| | | modulus | | | | | | | | | | | |

| | | | Unit | C. Ex. 11 | C. Ex. 12 | C. Ex. 13 | C. Ex. 14 | C. Ex. 15 | C. Ex. 16 |
|---|---|---|---|---|---|---|---|---|---|
| Composition | Component A | PC-1 | Parts | | | | | | |
| | | PC-2 | by | 100 | 100 | 100 | 100 | 100 | 100 |
| | Component B | B-1 | weight | | | | | | |
| | | B-2 | | | | | | | |
| | | B-3 | | | | | | | |
| | | B-8 | | | | | | | |
| | Comparative | B-5 | | 0.3 | 0.5 | 0.5 | | | |
| | component B | B-6 | | | | | 0.5 | | |
| | | B-7 | | | | | | 1 | 5 |
| | Component C | C-1 | | 0.3 | 0.3 | 0.3 | 0.3 | 0.3 | 0.3 |
| | | C-2 | | | | | | | |
| | Component D | D-1 | | 10 | 15 | | 15 | 15 | 15 |
| | | D-2 | | 10 | 15 | | 15 | 15 | 15 |
| | | D-3 | | | | 15 | | | |
| | Component E | E-1 | | | 10 | 10 | 10 | 10 | 10 |
| | | E-2 | | | | | | | |
| | Others | SL | | 0.5 | 0.5 | 0.5 | 0.5 | 0.5 | 0.5 |
| | | TMP | | 0.02 | 0.02 | 0.02 | 0.02 | 0.02 | 0.02 |
| Characteristic | Existence of halogen | | | None | None | None | Yes | None | None |
| properties | Heat | ΔMv | — | 700 | 900 | 1100 | 900 | 1000 | 1200 |
| | stability | | | | | | | | |
| | Flame | 2.0 mmt | — | V-1 | V-1 | V-1 | V-1 | V-1 | V-0 |
| | retardancy | | | | | | | | |
| | Heat | Deflection | ° C. | 133 | 140 | 130 | 140 | 136 | 115 |
| | resistance | temperature | | | | | | | |
| | | under load | | | | | | | |
| | Impact | Charpy | KJ/m² | 7 | 8 | 13 | 8 | 8 | 6 |
| | strength | impact | | | | | | | |
| | | strength | | | | | | | |
| | Stiffness | Flexural | MPa | 4400 | 6100 | 4000 | 6100 | 6100 | 6300 |
| | | modulus | | | | | | | |

Ex.: Example
C. Ex.: Comparative Example

As obvious from the above Tables 1 and 2, it is understood that the resin composition of the present invention has excellent flame retardancy and heat resistance and comprises a flame retardant containing no halogen from the viewpoint of environmental conservation.

### EFFECT OF THE INVENTION

The resin composition of the present invention is excellent in heat stability, flame retardancy and heat resistance. Since the resin composition of the present invention contains no halogen, it is useful from the viewpoint of environmental conservation. This resin composition can be provided by the production method of the present invention. The molded article of the present invention has excellent mechanical properties such as impact strength and stiffness and also excellent heat stability, flame retardancy and heat resistance.

### INDUSTRIAL FEASIBILITY

The resin composition of the present invention has excellent flame retardancy, heat resistance and stiffness and is therefore useful in various fields such as electronic and electric equipment, OA equipment, car parts and mechanical parts as well as agricultural materials, shipping containers, play tools and groceries.

1. A resin composition comprising 100 parts by weight of an aromatic polycarbonate resin (component A), 0.001 to 8 parts by weight of a flame retardant (component B) and 0.01 to 6 parts by weight of a fluorine-containing dripping inhibitor (component C), wherein
the flame retardant (component B) is an aromatic polymer in which a sulfonic acid group and/or a sulfonic acid base being introduced in an amount of 0.1 to 2.5 wt % in terms of sulfur.

2. The resin composition according to claim 1, wherein the flame retardant (component B) is an aromatic polymer in which a sulfonic acid group and/or a sulfonic acid base being introduced in an amount of 1 to 2.3 wt % in terms of sulfur.

3. The resin composition according to claim 1, wherein the sulfonic acid base of the component B contains an alkali metal element.

4. The resin composition according to claim 3, wherein the alkali metal element is potassium.

5. The resin composition according to claim 1, wherein the aromatic polymer contained in the component B is a polystyrene-based resin and/or an acrylonitrile styrene-based resin.

6. The resin composition according to claim 1 which comprises 1 to 50 parts by weight of at least one reinforcing filler (component D) selected from the group consisting of a fibrous inorganic filler (component D-1) and a lamellar inorganic filler (component D-2) based on 100 parts by weight of the component A.

7. The resin composition according to claim 6, wherein the component D-1 is at least one fibrous inorganic filler selected from the group consisting of glass fibers, glass milled fibers, wollastonite and carbon fibers.

8. The resin composition according to claim 6, wherein the component D-2 is at least one lamellar inorganic filler selected from the group consisting of glass flakes, mica and talc.

9. The resin composition according claim 1 which comprises 1 to 100 parts by weight of a ground product of an optical disk (component E) comprising a substrate essentially composed of an aromatic polycarbonate resin based on 100 parts by weight of the component A.

10. The resin composition according to claim 9, wherein the optical disk is a CD and/or a DVD.

11. A molded article obtained from the resin composition of claim 1.

12. A method of producing a resin composition by mixing together 100 parts by weight of an aromatic polycarbonate resin (component A), 0.001 to 8 parts by weight of a flame retardant (component B) and 0.01 to 6 parts by weight of a fluorine-containing dripping inhibitor (component C), wherein
the flame retardant (component B) is obtained by introducing a sulfonic acid group and/or a sulfonic acid base into an aromatic polymer in an amount of 0.1 to 2.5 wt % in terms of sulfur.
